(19) United States
(12) Patent Application Publication
(10) Pub. No.: US 2025/0369379 A1
(43) Pub. Date: Dec. 4, 2025

(54) ELECTRICALLY HEATED COLD LIGHT OFF CATALYST

(71) Applicant: FCA US LLC, Auburn Hills, MI (US)

(72) Inventors: Robbert DeBruijn, Washington, MI (US); Hans Kwok, Auburn Hills, MI (US); Srihari Kalluri, Ann Arbor, MI (US); Xiangdong Zhang, Auburn Hills, MI (US); Leopoldo Henrique Camargos, Minas Gerais (BR)

(21) Appl. No.: 18/679,758

(22) Filed: May 31, 2024

(51) Int. Cl. F01N 3/20; B60R 25/04; B60R 25/24; F02B 37/18

(52) U.S. Cl. CPC F01N 3/2026; B60R 25/04; B60R 25/24; F02B 37/18

(57) ABSTRACT

A control system for a vehicle having an engine and a main catalyst disposed in an exhaust system includes a cold light off catalyst (CLOC), an electrical heating element, and a controller. The CLOC is positioned in the exhaust system upstream of the main catalyst. The electrical heating element is disposed at the CLOC and configured to selectively heat the CLOC. The controller is configured to: determine an initialization event; activate the electrical heating element based on the initialization event; determine, subsequent to activating the electrical heating element, whether at least one of the CLOC has reached a CLOC operating temperature and the main catalyst has reached a main catalyst operating temperature; and command the electrical heating element to deactivate based on at least one of the CLOC reaching the CLOC operating temperate and the main catalyst reaching the main catalyst operating temperature.

### FIELD

The present application relates to vehicle emission systems and, more particularly, to techniques for controlling an electrically heated cold light off catalyst.

### BACKGROUND

As is known, pollutant emissions such as nitrogen oxides (NOx), carbon monoxide (CO), and hydrocarbon (HC) are temperature sensitive in aftertreatment systems. Such emission conversion begins at high temperatures such as over 350 C depending on catalyst formulation. Typically at engine startup, idle exhaust temperatures are much below the high temperatures needed for optimal catalyst efficiencies. An amount of time is needed for the exhaust to heat up from the typical exhaust temperatures to the elevated temperatures that satisfy a desired efficiency target. Operation of the engine during this heating up time is inefficient for conversion of such pollutants. Accordingly, a need exists in the art to improve upon efficiencies of aftertreatment systems.

### SUMMARY

According to one example aspect of the invention, a control system for a vehicle having an engine and a main catalyst disposed in an exhaust system includes a cold light off catalyst (CLOC), an electrical heating element, and a controller. The CLOC is positioned in the exhaust system upstream of the main catalyst. The electrical heating element is disposed at the CLOC and configured to selectively heat the CLOC. The controller is configured to: determine an initialization event; activate the electrical heating element based on the initialization event; determine, subsequent to activating the electrical heating element, whether at least one of the CLOC has reached a CLOC operating temperature and the main catalyst has reached a main catalyst operating temperature; and command the electrical heating element to deactivate based on at least one of the CLOC reaching the CLOC operating temperate and the main catalyst reaching the main catalyst operating temperature.

In some implementations, the control system further comprises a turbocharger.

In other implementations, the CLOC is positioned in a bypass passage of the exhaust system around a turbine of the turbocharger.

In additional implementations, the control system further comprises a CLOC valve that selectively routes exhaust flow from the engine between the turbine and the CLOC.

In examples, the controller is further configured to command the CLOC valve to a position that discontinues exhaust flow into the CLOC based on commanding the electrical heating element to deactivate.

In other examples, the initialization event comprises detecting a vehicle operator in proximity of the vehicle.

In additional examples, the initialization event comprises receiving a remote signal from a vehicle operator indicative of the vehicle operator intending to start the engine.

In other examples, the initialization event comprises detecting an unlocking of the vehicle.

According to another example aspect of the invention, a control system for a vehicle having an engine and a main catalyst disposed in an exhaust system includes a turbocharger, a cold light off catalyst (CLOC), an electrical heating element, and a controller. The CLOC is positioned upstream of the main catalyst in a bypass passage around the turbine. The electrical heating element is disposed at the CLOC and is configured to selectively heat the CLOC. The controller is configured to: determine an initialization event; activate the electrical heating element based on the initialization event; determine, subsequent to activating the electrical heating element, whether the exhaust system has reached an operating temperature; and command the electrical heating element to deactivate based on determining that the exhaust has reached operating temperature.

In some implementations, the controller determines whether the exhaust system has reached the operating temperature based on determining that the CLOC has reached a CLOC operating temperature.

In some implementations, the controller determines whether the exhaust system has reached the operating temperature based on determining that the main catalyst has reached a main catalyst operating temperature.

In other implementations, the control system further comprises a CLOC valve that selectively routes exhaust flow from the engine between the turbine and the CLOC.

In additional implementations, the controller is further configured to command the CLOC valve to a position that discontinues exhaust flow into the CLOC based on commanding the electrical heating element to deactivate.

In other examples, the initialization event comprises detecting a vehicle operator in proximity of the vehicle.

In additional examples, the initialization event comprises receiving a remote signal from a vehicle operator indicative of the vehicle operator intending to start the engine.

In other examples, the initialization event comprises detecting an unlocking of the vehicle.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a diagram of an example vehicle comprising a turbocharged engine incorporating an electrically heated cold light off catalyst (CLOC) and CLOC valve according to the principles of the present disclosure; and

FIG. 2 is a flow diagram of example control of the cold light off catalyst according to examples of the present disclosure.

### DETAILED DESCRIPTION

The present disclosure is directed toward emission control on turbocharged engines. A system and related techniques are described for controlling an electrically heated cold start light off catalyst (CLOC) where a CLOC valve is controlled to divert exhaust gas from the turbine of the turbocharger and through a small catalyst in a CLOC mode. The CLOC can achieve high efficiency quickly to treat the exhaust gas, while a much larger downstream catalyst is warming up. Control techniques disclosed herein provide methods for operating the CLOC.

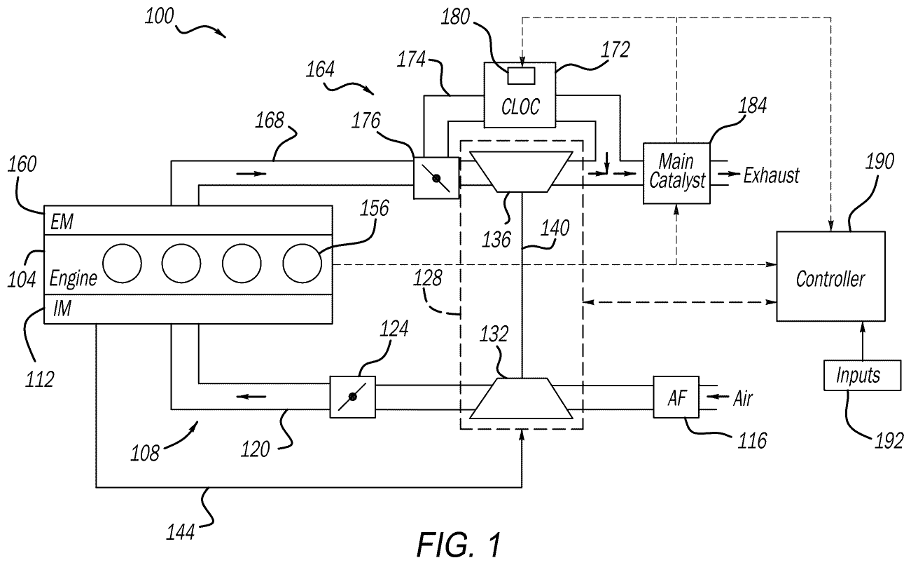

Referring now to FIG. 1, a diagram of an example vehicle or vehicle control system 100 is illustrated. The vehicle 100 includes an engine 104 configured to combust an air/fuel mixture to generate drive torque. The engine 104 includes an intake system 108 that draws fresh air into an intake manifold (IM) 112 through an air filter (AF) 116 and an induction passage 120. A throttle valve 124 regulates a flow of air through the induction passage 120. A turbocharger 128 comprises a compressor 132 (e.g., a centrifugal compressor) that pressurizes or forces the air through the induction passage 120. The compressor 132 is coupled to a turbine 136 (e.g., a twin-scroll turbine) of the turbocharger 136 via a shaft 140.

The pressurized air is distributed to a plurality of cylinders 156 and combined with fuel (e.g., from respective direct-injection or port-injection fuel injectors) to form an air/fuel mixture. While four cylinders are shown, it will be appreciated that the engine 104 could include any number of cylinders. The air/fuel mixture is compressed by pistons (not shown) within the cylinders 156 and combusted (e.g., via spark from respective spark plugs) to drive the pistons, which turn a crankshaft (not shown) to generate drive torque. The drive torque is then transferred to a driveline (not shown) of the vehicle 100, e.g., via a transmission (not shown). Exhaust gas resulting from combustion is expelled from the cylinders 156 and into an exhaust manifold (EM) 160 of the engine 104.

The exhaust gas from the exhaust manifold 160 is provided to an exhaust system 164 comprising an exhaust passage 168. Kinetic energy of the exhaust gas drives the turbine 136, which in turn drives the compressor 132 via the shaft 140. An electrically heated cold light off catalyst (CLOC) 172 includes a heating element 180. The CLOC 172 is routed upstream of the main catalyst 184. In the example shown, the CLOC 172 is positioned in a bypass passage 174 around the turbine 136. A CLOC valve 176 selectively controls exhaust flow into the turbine 136 of the turbocharger 128 and/or into the CLOC 172 via the bypass passage 174. Explained further, the CLOC valve 176 moves between a fully open position whereby all exhaust gas is routed to the turbine 136, a fully closed position whereby all exhaust gas is routed to the CLOC 172, and infinite positions therebetween causing a blend of exhaust to be routed to both of the turbine 136 and the CLOC 172.

As used herein a “CLOC mode” is used to refer to the controller 190 commanding the CLOC valve 176 to rout at least some exhaust to the CLOC 172. A main exhaust gas treatment system, or main catalyst 184, such as a catalytic converter, treats exhaust gas to decrease or eliminate emissions before it is released into the atmosphere. All exhaust gas regardless of passing through the turbine 136 or the CLOC 172 is directed to the main exhaust gas treatment system 184. The CLOC 172 includes a small catalyst that can reach high efficiency quickly and treat the exhaust gas such as when the main catalyst 184 has yet to reach optimal operating temperature. As will become appreciated therein, the controller 190 commands the heating element 180 to activate upon an initialization event (such as detecting a vehicle operator in proximity to the vehicle 100, initiating an unlocking of the vehicle, or otherwise communicating remotely to the vehicle 100 a condition indicative of a user intending to start the engine 104 in a short amount of time).

Lubrication oil from the engine 104 is routed through an oil line 144 to the turbocharger 128 to lubricate components of the turbocharger 128. In examples, the oil is sourced from the engine 104 at the sump.

The controller 190 controls operation of the vehicle 100. Examples of components controlled by the controller 190 include the engine 104, the throttle valve 124, the CLOC valve 176, and the heating element 180. It will be appreciated that the controller 190 controls specific components of the vehicle 100 that are not illustrated, such as, but not limited to, fuel injectors, spark plugs, an EGR valve, a VVC system (e.g., intake/exhaust valve lift/actuation), a transmission, and the like. The controller 190 controls operation of these various components based on measured and/or modeled parameters. Inputs 192 such as one or more sensors (including a temperature sensor 194) are configured to measure one or more parameters, and communicate signals indicative thereof to the controller 190 (pressures, temperatures, speeds, etc.) as discussed in greater detail herein. Other parameters could be modeled by the controller 190, such as the temperature of the main catalyst 184 to determine a mean temperature of the main catalyst 184. Similarly, the temperature of the CLOC 172 can be modeled by the controller 190 to determine a mean temperature of the CLOC 172.

In general, once the controller 190 determines that the main catalyst 184 is up to working temperature, the controller 190 can communicate a signal to the heating element 180 to turn off the heating element 180 as the CLOC 172 is no longer needed. Additionally, the controller 190 can communicate a signal to the CLOC valve 176 to close the CLOC valve 176 and force the exhaust through the turbo 128 and not through the CLOC 172 as the CLOC 172 is no longer needed. In other examples, the electric heating element 180 can be activated based on the CLOC 172 not satisfying an operating temperature. Explained differently, once the controller 190 has determined that the CLOC 172 has reached a suitable operating temperature, the controller 190 can communicate a signal to the heating element 180 to deactivate the heating element 180 as it is no longer needed. The controller 190 is also configured to perform the engine/turbocharger control techniques.

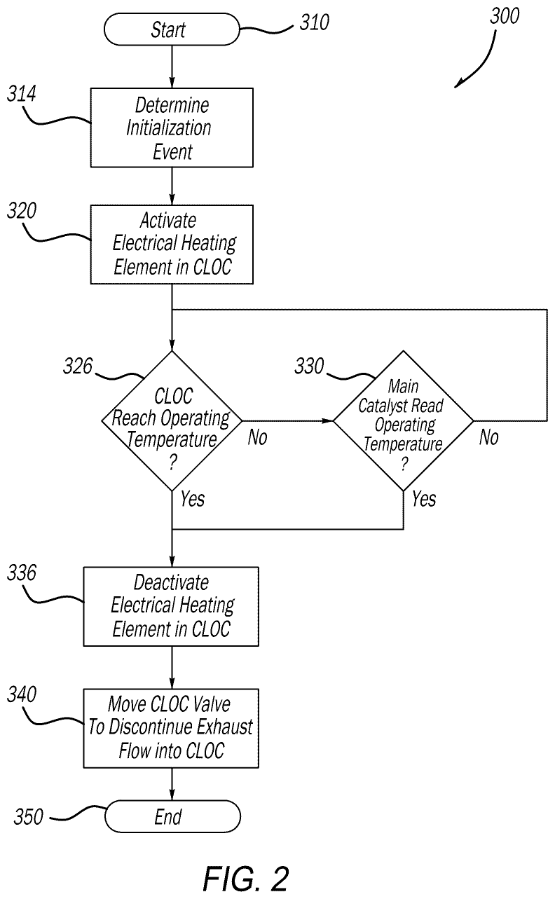

Turning now to FIG. 2, a flow chart of an example method 300 of operating the CLOC 172 and CLOC valve 176 is illustrated. For explanatory purposes, components of the vehicle 100 will be referenced, but it will be appreciated that this method 300 could be used for any engine having a turbocharger and CLOC. Control starts at 310. At 314 control determines whether an initialization event has occurred. An initialization event can be any event that denotes a vehicle operator wishing to start the engine 104 soon. By way of example only, such initialization events can include detecting a vehicle operator in proximity to the vehicle 100 (such as by detecting a key fob and/or mobile device), initiating an unlocking of the vehicle 100, or otherwise communicating remotely to the vehicle 100 a condition indicative of a user intending to start the engine 104 in a short amount of time.

At 320 control activates the electrical heating element 180 based on the determined initialization event. At 326 control determines whether the CLOC 172 has reached a suitable operating temperature. If not, control proceeds to 330. At 330 control determines whether the main catalyst 184 has reached a suitable operating temperature. If not, control loops to 326.

If control determines that the CLOC 172 has reached suitable operating temperature at 236, or if the main catalyst 184 has reached a suitable operating temperature at 330, control deactivates the electrical heating element 180 in the CLOC 172. As used herein a suitable operating temperature is a suitable elevated operating temperature that operates the CLOC 172 (and/or the main catalyst 194 at optimal efficiency. The temperatures can be determined with models in the controller 190 and/or measured temperatures from the inputs 192 including the temperature sensor 194. At 340, control moves the CLOC valve 176 to a position whereby exhaust flow is discontinued to be routed into the CLOC 172. At 350 control ends.

It will be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

1. A control system for a vehicle having an engine and a main catalyst disposed in an exhaust system, the control system comprising:
a cold light off catalyst (CLOC) positioned in the exhaust system upstream of the main catalyst;
an electrical heating element disposed at the CLOC and configured to selectively heat the CLOC;
a turbocharger, wherein the CLOC is positioned in a bypass passage of the exhaust system around a turbine of the turbocharger;
a CLOC valve that selectively routes all exhaust flow from the engine between the turbine and the CLOC, the CLOC valve moveable between a fully open position whereby all exhaust gas is routed to the turbine, and a fully closed position whereby all exhaust gas is routed to the CLOC; and
a controller configured to:
determine an initialization event;
activate the electrical heating element based on the initialization event;
command the CLOC valve to the fully closed position;
determine, subsequent to activating the electrical heating element, whether at least one of the CLOC has reached a CLOC operating temperature and the main catalyst has reached a main catalyst operating temperature; and
command the electrical heating element to deactivate based on at least one of the CLOC reaching the CLOC operating temperature and the main catalyst reaching the main catalyst operating temperature.

2-4. canceled

5. The control system of claim 1, wherein the controller is further configured to:
command the CLOC valve to a position that discontinues exhaust flow into the CLOC based on commanding the electrical heating element to deactivate.

6. The control system of claim 1, wherein the initialization event comprises detecting a vehicle operator in proximity of the vehicle.

7. The control system of claim 1, wherein the initialization event comprises receiving a remote signal from a vehicle operator indicative of the vehicle operator intending to start the engine.

8. The control system of claim 1, wherein the initialization event comprises detecting an unlocking of the vehicle.

9. A control system for a vehicle having an engine and a main catalyst disposed in an exhaust system, the control system comprising:
a turbocharger having a turbine;
a cold light off catalyst (CLOC) positioned upstream of the main catalyst in a bypass passage around the turbine;
an electrical heating element disposed at the CLOC and configured to selectively heat the CLOC;
a CLOC valve that selectively routes all exhaust flow from the engine between the turbine and the CLOC, the CLOC valve moveable between a fully open position whereby all exhaust gas is routed to the turbine, and a fully closed position whereby all exhaust gas is routed to the CLOC; and
a controller configured to:
determine an initialization event;
activate the electrical heating element based on the initialization event;
command the CLOC valve to the fully closed position;
determine, subsequent to activating the electrical heating element, whether the exhaust system has reached an operating temperature; and
command the electrical heating element to deactivate based on determining that the exhaust gas has reached the operating temperature.

10. The control system of claim 9, wherein the controller determines whether the exhaust system has reached the operating temperature based on determining that the CLOC has reached a CLOC operating temperature.

11. The control system of claim 9, wherein the controller determines whether the exhaust system has reached the operating temperature based on determining that the main catalyst has reached a main catalyst operating temperature.

12. canceled

13. The control system of claim 9, wherein the controller is further configured to:
command the CLOC valve to a position that discontinues exhaust flow into the CLOC based on commanding the electrical heating element to deactivate.

14. The control system of claim 9, wherein the initialization event comprises detecting a vehicle operator in proximity of the vehicle.

15. The control system of claim 9, wherein the initialization event comprises receiving a remote signal from a vehicle operator indicative of the vehicle operator intending to start the engine.

16. The control system of claim 9, wherein the initialization event comprises detecting an unlocking of the vehicle.
